(19) United States
(12) Patent Application Publication
(10) Pub. No.: US 2025/0294104 A1
(43) Pub. Date: Sep. 18, 2025

(54) MEDIUM DISCHARGE DEVICE AND IMAGE READING APPARATUS

(71) Applicant: SEIKO EPSON CORPORATION, Tokyo (JP)

(72) Inventors: Seiji TEZUKA, KITAKYUSHU-SHI (JP); Masaki NAMIKI, KITAKYUSHU-SHI (JP)

(21) Appl. No.: 19/077,290

(22) Filed: Mar. 12, 2025

(30) Foreign Application Priority Data
Mar. 14, 2024 (JP) 2024-039846

(51) Int. Cl. H04N 1/00

(52) U.S. Cl. CPC H04N 1/00604; H04N 1/00591; H04N 1/00708

(57) ABSTRACT

A medium discharge device includes a discharge part that discharges a medium, a placement part that has a placement surface on which the medium discharged from the discharge part is placed and that is extendable or contractable in a direction along the placement surface, and an extension and contraction change part that extends or contracts the placement part. The placement part includes a base tray and an auxiliary tray that is movable in an extension and contraction direction relative to the base tray. The extension and contraction change part is configured to extend or contract the placement part according to a size of the medium.

The present application is based on, and claims priority from JP Application Serial Number 2024-039846, filed Mar. 14, 2024, the disclosure of which is hereby incorporated by reference herein in its entirety.

### BACKGROUND

### 1. Technical Field

The present disclosure relates to a medium discharge device and an image reading device.

### 2. Related Art

An example of this type of device is a device described in JP-A-2019-210077.

JP-A-2019-210077 discloses a sheet discharge device in which a sheet on which an image has been read by a reading unit is loaded onto a sheet discharge placement part via a discharge roller pair.

When a size of the sheet discharged to the sheet discharge placement part becomes different, for example, when the sheet changes from A4 size to A3 size, there is a risk that a leading edge of the sheet will protrude from the sheet discharge placement part, hang down, and fall due to its own weight. Therefore, there is a sheet discharge placement part that has an auxiliary tray so that a length of the sheet discharge placement part can be changed according to a size of the sheet. In other words, there is a sheet discharge placement part having a structure in which a user can extend the auxiliary tray to increase a size of a sheet placement surface of the sheet discharge placement part.

However, in this case, it is necessary for the user to operate the auxiliary tray himself, but there is a problem that the user may forget to extend the auxiliary tray or the sheet may fall from the sheet discharge placement part. Further, a degree to which the auxiliary tray is extended tends to vary depending on the user, but there is also a problem that it is unlikely that the user himself will be aware of this.

### SUMMARY

To solve the above problem, a medium discharge device according to the present disclosure includes a discharge part configured to discharge a medium, a placement part having a placement surface on which the medium discharged from the discharge part is placed and configured to extend or contract in a direction along the placement surface, and an extension and contraction change part configured to extend or contract the placement part, wherein the extension and contraction change part extends or contracts the placement part according to a size of the medium.

Further, an image reading device according to the present disclosure includes the medium discharge device according to any one of first to ninth aspects to be described below, and a reading unit configured to read an image of the medium transported toward the medium discharge device.

### BRIEF DESCRIPTION OF THE DRAWINGS

FIG. 1 is a schematic diagram of a side cross section of an image reading device according to Embodiment 1.

FIG. 2 is a schematic diagram of a side cross section of the image reading device according to Embodiment 1.

FIG. 3 is a schematic diagram of a side cross section of the image reading device according to Embodiment 1.

FIG. 4 is a schematic diagram of a side cross section of the image reading device according to Embodiment 1.

FIG. 5 is a schematic diagram of a side cross section of an image reading device according to Embodiment 2.

FIG. 6 is a schematic diagram of a side cross section of the image reading device according to Embodiment 2.

FIG. 7 is a rear view of the placement part according to Embodiment 2, as seen from the back.

FIG. 8 is a rear view of the placement part according to Embodiment 2, as seen from the back.

### DESCRIPTION OF EMBODIMENTS

Hereinafter, the present disclosure will be described in brief.

A medium discharge device according to a first aspect of the present disclosure includes a discharge part configured to discharge a medium, a placement part having a placement surface on which the medium discharged from the discharge part is placed and configured to extend or contract in a direction along the placement surface, and an extension and contraction change part configured to extend or contract the placement part, wherein the extension and contraction change part extends or contracts the placement part according to a size of the medium.

According to the present aspect, the extension and contraction change part that extends and contracts the placement part is included, and the extension and contraction change part extends and contracts the placement part according to the size of the medium. That is, the extension and contraction change part is configured to extend and contract the placement part. This makes it possible to reduce the concern that the user forgets to extend the placement part, as in a structure of the related art in which the placement part is extended or contracted manually. Also, it is possible to curb a variation in a degree of extension of the placement part.

A medium discharge device according to a second aspect of the present disclosure is an aspect dependent on the first aspect, in which the placement part is pivotable in a vertical direction with a base end part as a pivot fulcrum, and the extension and contraction change part extends the placement part in interlock with the pivoting of the placement part.

According to the present aspect, the extension and contraction change part is configured to extend the placement part in interlock with the pivoting of the placement part. Accordingly, it is possible to reliably extend or contract the placement part by pivoting the placement part in the vertical direction, making the device user-friendly.

A medium discharge device according to a third aspect of the present disclosure is an aspect dependent on the second aspect, in which the extension and contraction change part extends the placement part in interlock with the placement part pivoting upward and then pivoting downward.

According to the present aspect, the extension and contraction change part is configured to extend the placement part in interlock with the upward pivoting of the placement part and the subsequent downward pivoting. This makes it possible to easily realize a state where the placement part is extended in the same posture as the posture before the placement part is extended.

A medium discharge device according to a fourth aspect of the present disclosure is an aspect dependent on the third aspect, in which the placement part includes a base tray, an auxiliary tray configured to be movable in an extension and contraction direction relative to the base tray, and an elastic member configured to apply an elastic force to the auxiliary tray in a contraction direction, the extension and contraction change part includes an interlocking lever configured to interlock with the pivoting of the placement part, and the interlocking lever moves the auxiliary tray in a direction in which the auxiliary tray extends against the elastic force in interlock with the pivoting of the placement part.

According to the present aspect, the extension and contraction change part includes the interlocking lever that is interlocked with the pivoting of the placement part, and the interlocking lever moves the auxiliary tray in a direction in which the auxiliary tray is extended against the elastic force of the elastic member in interlock with the pivoting of the placement part. That is, the extension and contraction change part is configured to extend the placement part using the interlocking lever which is interlocked with the pivoting of the placement part. This makes it possible to simplify a structure and extend the placement part.

The medium discharge device according to a fifth aspect of the present disclosure is an aspect dependent on the first aspect, and includes a control unit configured to control the extension and contraction change part, wherein the control unit extends or contracts the placement part based on size information about the medium.

According to the present aspect, the control unit that controls the extension and contraction change part is configured to extend or contract the placement part based on the size information of the medium. Accordingly, the placement part can be automatically extended or contracted by the control unit, making the device user-friendly.

A medium discharge device according to a sixth aspect of the present disclosure is an aspect dependent on the fifth aspect, and the placement part includes a base tray, and an auxiliary tray configured to be movable in an extension and contraction direction relative to the base tray, the extension and contraction change part includes a drive pinion, and a power transmission mechanism configured to transmit rotational power of the drive pinion to the auxiliary tray to move the auxiliary tray, and the control unit controls the rotation of the drive pinion based on the size information about the medium to extend or contract the placement part.

According to the present aspect, the extension and contraction change part includes the drive pinion, and the power transmission mechanism that transmits the rotational power of the drive pinion to the auxiliary tray to move the auxiliary tray, and the control unit controls the rotation of the drive pinion based on the size information of the medium to extend or contract the placement part. This makes it possible to automatically extend the placement part with a simple structure in which the drive pinion and the power transmission mechanism are used.

A medium discharge device according to a seventh aspect of the present disclosure is an aspect dependent on the fifth aspect, and includes a sensor capable of acquiring information about the size of the medium, wherein the control unit extends and contracts the placement part based on the information acquired by the sensor.

The present aspect can also be dependent on the sixth aspect.

According to the present aspect, the control unit extends and contracts the placement part based on the information acquired by the sensor. This makes it possible to automatically extend or contract the placement part even when the user inputs the size information of the medium from an operation panel or the like.

The medium discharge device according to an eighth aspect of the present disclosure is an aspect dependent on the seventh aspect, and the sensor is disposed at a downstream end in a direction in which the placement part extends and contracts.

According to the present aspect, when the sensor detects the medium in a state where the placement part is not extended, it is possible to determine that the medium has a size requiring extension of the placement part. This makes it possible to appropriately extend or contract the placement part according to the size of the medium. Further, it is possible to curb the medium falling off the placement part.

The medium discharge device according to a ninth aspect of the present disclosure is an aspect dependent on the fifth aspect, in which the placement part is pivotable in a vertical direction with a base end as a pivot fulcrum, the medium discharge device includes a placement angle change part configured to change a placement angle of the placement surface relative to a horizontal plane by pivoting the placement part, and the control unit drives the placement angle change part to change the placement angle, based on information about a discharged state of the medium placed on the placement surface.

Here, “the information about the discharged state of the medium” means information about alignment of a plurality of sheets of the medium discharged to the placement part. In a specific example, this is information about the quality of the alignment of the medium obtained by sensing with a sensor such as a camera, or information related to the alignment such as a size or type of the medium, a discharge speed from the discharge part, and an inclination angle of the placement surface with respect to a horizontal plane.

The present aspect can also be dependent on any one of the sixth to eighth aspects.

For example, when the medium discharged later comes into contact with the medium first discharged from the discharge part and placed on the placement part, the previously discharged medium may be pushed, which may degrade the alignment. Further, when a discharge speed of the medium discharged from the discharge part is high, it is easy for the medium to move more forward relative to the placement part, which degrades the alignment.

According to the present aspect, the control unit drives the placement angle change part to change the placement angle, based on information about a discharged state of the medium placed on the placement surface. This makes it possible to appropriately curb a forward movement of the medium in the placement part and improve alignment.

The image reading device according to a tenth aspect of the present disclosure includes the medium discharge device according to any one of the first to ninth aspects, and a reading unit configured to read an image of the medium transported toward the medium discharge device.

According to the present aspect, with the image reading device, it is possible to achieve the same effects as those of any one of the first to ninth aspects.

### Embodiments

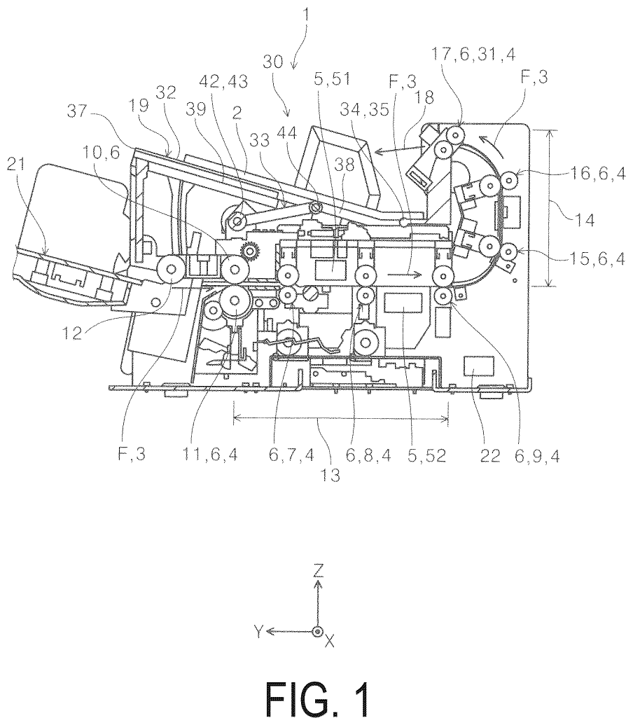

Hereinafter, an embodiment of a medium discharge device and an image reading device according to the present disclosure will be specifically described with reference to FIGS. 1 to 8.

In the following description, three mutually orthogonal axes are an X-axis, a Y-axis, and a Z-axis, respectively, as shown in each figure. Directions indicated by arrows of three axes (X, Y, Z) are +directions of the respective directions, and opposite directions are −directions. A Z-axis direction corresponds to a vertical direction, that is, a direction in which gravity acts, and a +Z direction indicates a vertical upward direction, and a −Z direction indicates a vertical downward direction. The X-axis direction and the Y-axis direction correspond to a horizontal direction. A +Y direction indicates a front direction of the image reading device, and a −Y direction indicates a rear direction of the device. A +X direction indicates a right direction of the device, and a −X direction indicates a left direction of the device.

### Overall Configuration of Image Reading Device

An overall configuration of the image reading device 1 of the present embodiment will first be described based on FIG. 1.

The image reading device 1 of the present embodiment is a document scanner capable of reading an image of a medium 2. Here, the image means something visually recorded on the medium 2, such as characters, figures, tables, pictures, and photographs. The medium is not limited to a sheet, but also includes a card and a booklet. The image reading device 1 is not limited to a scanner, and may be a copy machine, a facsimile machine, and the like.

As illustrated in FIG. 1, the image reading device 1 includes a medium transport device 4 that transports the medium 2 in a transport direction F along the transport path 3, and a reading unit 5 that reads an image of the medium 2 transported by the medium transport device 4.

In the present embodiment, the reading unit 5 that reads the image of the medium 2 includes two reading units including a first reading unit 51 and a second reading unit 52. The first reading unit 51 is located above the transport path 3 and reads an image of a first side of the medium 2. The second reading unit 52 is located below the transport path 3 and reads an image of a second side opposite to the first side. The reading unit 5 includes, for example, a contact image sensor (CIS) type sensor or a charge coupled device (CCD) type sensor.

Further, a transport part 6 that transports the medium 2 in the transport direction F along the transport path 3 is included. The transport part 6 includes a first transport roller pair 7 provided upstream of the first reading unit 51, a second transport roller pair 8 provided upstream of the second reading unit 52 located downstream of the first reading unit 51, and a third transport roller pair 9 provided downstream of the second reading unit 52.

The first transport roller pair 7, the second transport roller pair 8, and the third transport roller pair 9 are each configured of a drive roller and a driven roller in a pair that are rotated by power of a drive source such as a motor (not illustrated).

A roller pair of feeding roller 10 and separation roller 11 are disposed upstream of the first transport roller pair 7 in the transport direction F. The feeding roller 10 is a drive roller that is rotated by the power of the drive source such as a motor (not illustrated), and transports the medium 2 in the transport direction F.

The separation roller 11 is a drive roller that is rotated by the power of a drive source (not illustrated), and is a roller that separates one sheet from a plurality of sheets of the medium 2. Here, the separation roller 11 rotates in a direction in which the medium 2 is sent upstream (the +Y direction) in the transport direction F by the power of the drive source. The separation roller 11 includes a torque limiter (not illustrated), and when a torque exceeding a set value is applied to this torque limiter, the separation roller 11 rotates in a driven manner in a direction in which the medium 2 is sent downstream (−Y direction) in the transport direction F.

A pick roller 12 is disposed is upstream of the separation roller 11. The pick roller 12 is a drive roller that is rotated by the power of the drive source (not illustrated), and picks up the medium 2 and sends the medium 2 in the transport direction F.

In the present embodiment, a U-turn path 14 is provided downstream of a straight path 13 from the feeding roller 10 to the third transport roller pair 9, that is, downstream of the third transport roller pair 9. In the U-turn path 14, a fourth transport roller pair 15, a fifth transport roller pair 16, and a discharge roller pair 17 as the transport part 6 are disposed in this order along the transport direction F. The fourth transport roller pair 15, the fifth transport roller pair 16, and the discharge roller pair 17 are also configured of a drive roller and a driven roller in a pair that are rotated by the power of the drive source (not illustrated).

The placement part 19 receiving the medium 2 discharged in a discharge direction 18 from the discharge roller pair 17 is disposed above the straight path 13 to make the device compact.

In FIG. 1, a reference numeral 21 denotes a medium setting part that sets the medium 2 that is a reading target.

The medium 2 on the medium setting part 21 is picked up by the pick roller 12 and sent in the transport direction F. The medium setting part 21 is configured to move up and down due to power of a drive source (not illustrated). When the medium 2 set in the medium setting part 21 is sent in the transport direction F, the medium setting part 21 is first moved upward (in the +Z direction) due to power transmitted from the drive source (not illustrated), and the topmost medium 2 stops in a state where the topmost medium 2 comes into contact with the pick roller 12. In this state, the pick roller 12 is rotated so that the medium 2 is sent in the transport direction F, and a leading edge of the medium 2 reaches a nip position of a roller pair of the feeding roller 10 and the separation roller 11.

In the case of a multi-feed state where a plurality of sheets of the medium 2 are sent, one sheet is separated by the separation roller 11, and transported in the transport direction F by the first transport roller pair 7, and reading of the image on the first side of the medium 2 is executed the first reading unit 51.

Further, the medium 2 read by the first reading unit 51 is transported by the second transport roller pair 8, and reading of an image on the second side of the medium 2, which is opposite to the first side, is performed by the second reading unit 52.

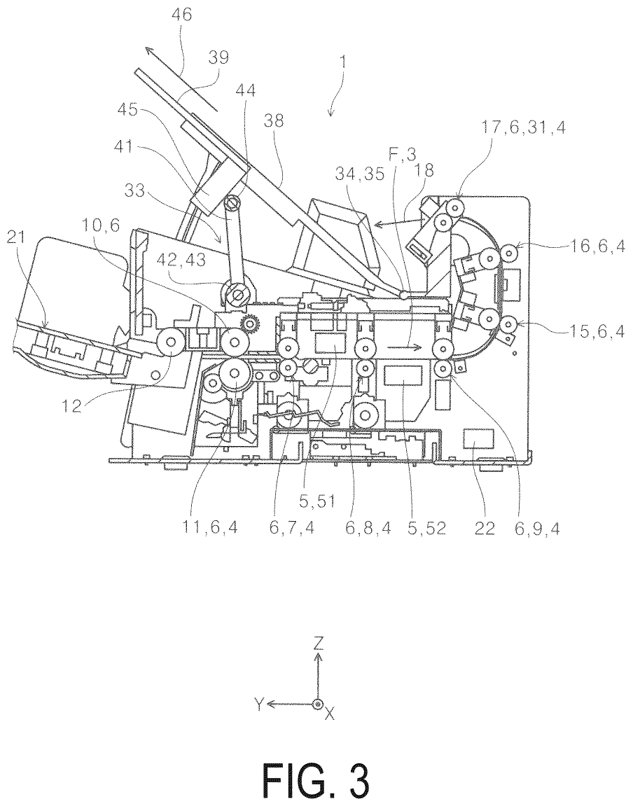

In FIG. 3, a reference numeral 22 denotes a control unit. The control unit 22 controls the driving of each drive source and a reading operation of the reading unit 5 in association with the transport of the medium 2.

The control unit 22 includes a CPU, a flash ROM, and a RAM. The CPU performs various arithmetic processing according to programs stored in the flash ROM, and controls an operation of the overall image reading device 1. The flash ROM, which is an example of a storage means, is a non-volatile memory that can be read and written. The RAM, which is an example of a storage means, temporarily stores various types of information.

### Embodiment 1

### Medium Discharge Device

The image reading device 1 includes a medium discharge device 30. The medium discharge device 30 of Embodiment 1 will be described with reference to FIG. 1 to FIG. 4.

The medium discharge device 30 of the present embodiment includes a discharge roller pair 17 as a discharge part 31 that discharges the medium 2, and a placement part 19 having a placement surface 32 on which the medium 2 discharged in the discharge direction 18 from the discharge part 31 is placed. The placement part 19 is configured to extend or contract in a direction 46 (FIG. 3) along the placement surface 32. That is, the placement part 19 is configured to be able to extend the length of the placement surface 32. The medium discharge device 30 also includes an extension and contraction change part 33 that extends or contracts the placement part 19. The extension and contraction change part 33 is configured to extend or contract the placement part 19 according to the size of the medium 2.

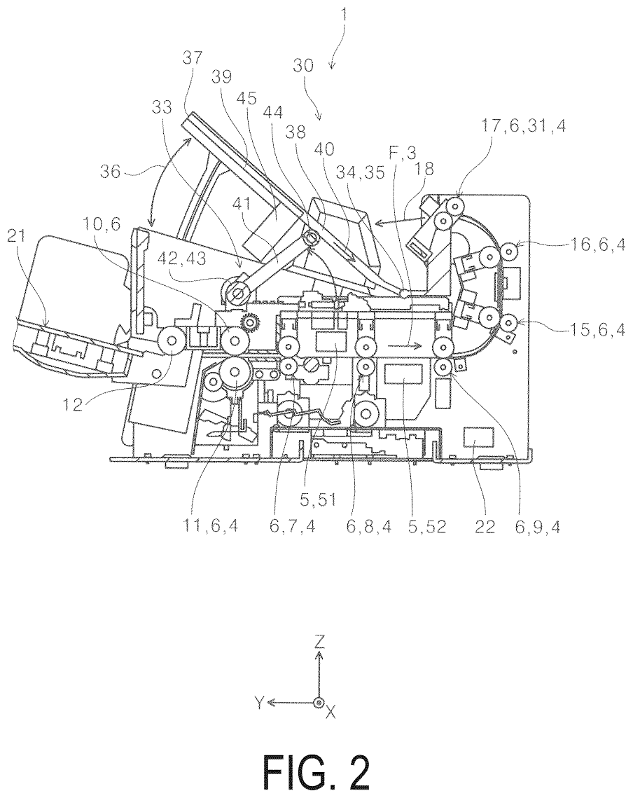

In the present embodiment, the placement part 19 is configured to be pivotable in a vertical direction 36 (FIG. 2) with a base end 34 as a pivot fulcrum 35. That is, the placement part 19 has a structure in which the placement part 19 can be pivoted by the user lifting a leading edge portion 37 upward.

In the present embodiment, the placement part 19 includes a base tray 38, and an auxiliary tray 39 that can move in an extension and contraction direction (a direction 46 along the placement surface 32) relative to the base tray 38. A projection part 45 is provided at a base end of the auxiliary tray 39. The projection part 45 is a plate-shaped member that protrudes downward from the auxiliary tray 39. Further, an elastic force is applied to the auxiliary tray 39 in a contraction direction toward the base end 34 by an elastic member 40 (FIG. 2). The elastic member 40 is, for example, a coil spring.

The extension and contraction change part 33 is configured to extend the placement part 19 in interlock with the pivoting of the placement part 19. Specifically, the extension and contraction change part 33 includes an interlocking lever 41 that interlocks with the pivoting of the placement part 19. The interlocking lever 41 includes one end part 42 as a pivot fulcrum 43, and the other end part 44 slidably coupled to the base tray 38.

As illustrated in FIG. 2, when the leading edge portion 37 of the placement part 19 is pivoted up and down with the base end 34 as the pivot fulcrum 35, the interlocking lever 41 slides in an extension and contraction direction that is a direction along the placement surface 32 in a state where the other end part 44 is coupled to the base tray 38. That is, the interlocking lever 41 pivots while the other end part 44 sliding in the direction along the placement surface 32 with the one end part 42 as the pivot fulcrum 43. The interlocking lever 41 is configured to be released from a coupled state with the base tray 38 after the other end part 44 reaches a position at a vertical posture directly above when the placement part 19 pivots further upward.

FIG. 3 illustrates a state where the other end part 44 of the interlocking lever 41 is released from the coupled state with the base tray 38 and is pivoted under its own weight to press the projection part 45. In order to assist the pivoting of the interlocking lever 41 under its own weight, a torsion coil spring (not illustrated) may be provided at the base end 34.

The other end part 44 of the interlocking lever 41 further pivots under its own weight from the state in FIG. 3, to press the projection part 45 of the auxiliary tray 39. Accordingly, the auxiliary tray 39 moves in an extension direction, and the placement part 19 changes to an extended state.

That is, the interlocking lever 41 moves the auxiliary tray 39 in a direction in which the auxiliary tray 39 extends against an elastic force of the elastic member 40 in interlock with the pivoting of the placement part 19.

In the present embodiment, the extension and contraction change part 33 is configured to extend the placement part 19 in interlock with the upward pivoting (the +Z direction) and subsequent downward pivoting (the −Z direction) of the placement part 19. <Step of Extending Placement Part>

(1) When it is necessary to extend the placement part 19, the user pivots the placement part 19 upward from the state in FIG. 1. Accordingly, the interlocking lever 41 pivots in interlock with such pivoting and enters the state in FIG. 2.

(2) Further, when the placement part 19 is pivoted upward, the interlocking lever 41 further pivots in interlock with such pivoting, and the other end part 44 of the interlocking lever 41 comes into contact with the projection part 45 and begins to press against the elastic force of the elastic member 40, so that the auxiliary tray 39 moves in the extension direction and enters the state in FIG. 3.

(3) Further, the placement part 19 is pivoted to an uppermost position and then changed to downward pivoting.

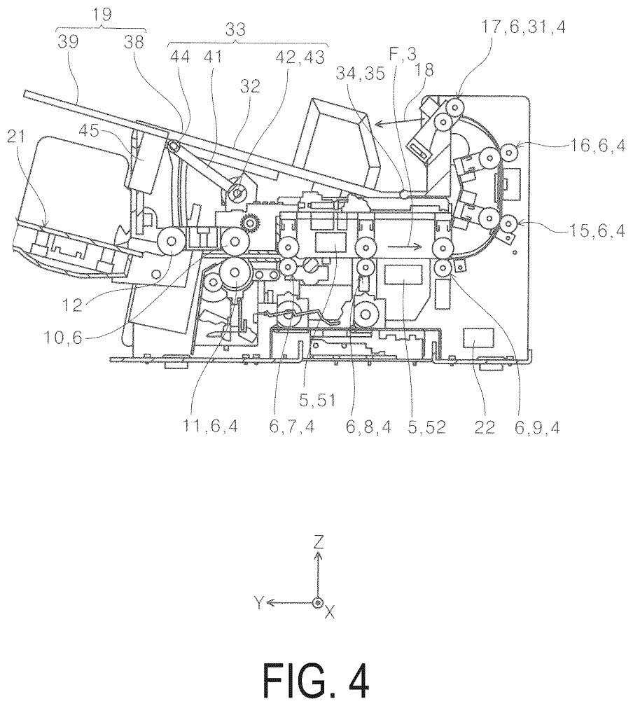

(4) The auxiliary tray 39 is moved to a most extended position and stopped due to the downward pivoting of the placement part 19. The placement part 19 returns to an original position before the pivoting and enters the state in FIG. 4.

With proceeding in an opposite direction from (1) to (4), the elastic force of the elastic member 40 is applied to the auxiliary tray 39 in the contraction direction, resulting in return from the state in FIG. 4 to the state in FIG. 1. In this case, when return from the state in FIG. 3 to the state in FIG. 2 occurs, the other end part 44 of the interlocking lever 41 returns to the coupled state with the base tray 38.

### Variations

The extension and contraction change part 33 of the present embodiment may be configured as follows, instead of the configuration described above.

The interlocking lever 41 is configured so that the other end part 44 is always pivoted in the +Y direction due to an elastic force of an elastic member such as a torsion coil spring (not illustrated). Further, when the placement part 19 is at a position illustrated in FIG. 1, the other end part 44 of the interlocking lever 41 is pressed downward from the base tray 38 and suppressed. When the placement part 19 is pivoted upward to enter the state in FIG. 2, the placement part 19 can be pivoted in the +Y direction due to the elastic force of the elastic member. Accordingly, the state in FIG. 3 and the state in FIG. 4 are achieved.

### Description of Effects of Embodiment 1

(1) In the present embodiment, the extension and contraction change part 33 that extends and contracts the placement part 19 is included, and the extension and contraction change part 33 extends and contracts the placement part 19 according to the size of the medium. That is, the extension and contraction change part 33 is configured to extend and contract the placement part 19. This makes it possible to reduce the concern that the user forgets to extend the placement part 19, as in a structure of the related art in which the placement part 19 is extended or contracted manually. Also, since a degree of extension of the placement part 19 is not manual, it is possible to curb a variation in degree of extension.

(2) Further, in the present embodiment, the extension and contraction change part 33 is configured to extend the placement part 19 in interlock with the pivoting of the placement part 19. Accordingly, it is possible to reliably extend or contract the placement part 19 by pivoting the placement part 19 in the vertical direction, making the device user-friendly.

(3) Further, in the present embodiment, the extension and contraction change part 33 is configured to extend the placement part 19 in interlock with the upward pivoting of the placement part 19 and the subsequent downward pivoting. This makes it possible to easily realize a state where the placement part 19 is extended in the same posture as the posture before the placement part 19 is extended.

(4) Further, in the present embodiment, the extension and contraction change part 33 includes the interlocking lever 41 that is interlocked with the pivoting of the placement part 19, and the interlocking lever 41 moves the auxiliary tray 39 in a direction in which the auxiliary tray 39 is extended against the elastic force of the elastic member 40 in interlock with the pivoting of the placement part 19. That is, the extension and contraction change part is configured to extend the placement part 19 using the interlocking lever 41 which is interlocked with the pivoting of the placement part 19. This makes it possible to simplify a structure and extend the placement part 19.

### Embodiment 2

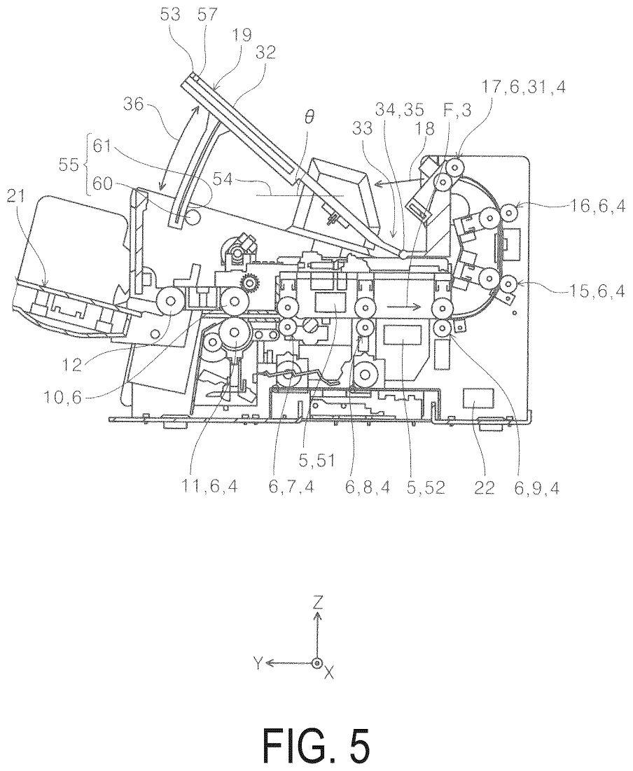

Next, the medium discharge device 30 according to Embodiment 2 will be described with reference to FIGS. 5 to 8. The same parts as those in Embodiment 1 are denoted by the same reference numerals, and description of configurations and corresponding effects thereof will be omitted.

The medium discharge device 30 according to Embodiment 1 has a structure in which, when the placement part 19 is pivoted in the vertical direction 36, the extension and contraction change part 33 extends or contracts the placement part 19 in interlock with the pivoting as described above, whereas a medium discharge device 30 according to Embodiment 2 has a structure in which pivoting of a placement part 19 is not necessary, and the placement part 19 is automatically extended or contracted by using power of a driving source such as a motor. Hereinafter, detailed description will be given.

As illustrated in FIG. 5, the medium discharge device 30 according to Embodiment 2 includes a control unit 22 that controls the extension and contraction change part 33. The control unit 22 is configured to extend or contract the placement part 19 based on size information of the medium 2. The size information of the medium 2 is input from an operation panel (not illustrated) by a user. As will be described later, the size information of the medium 2 may be acquired by a sensor 57 and sent to the control unit 22.

The control unit 22 also controls the driving of the drive source and a reading operation of the reading unit 5, as in Embodiment 1.

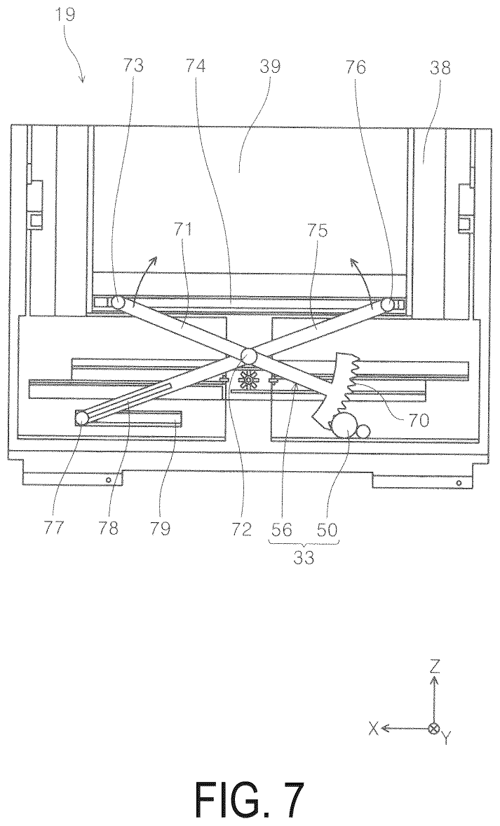

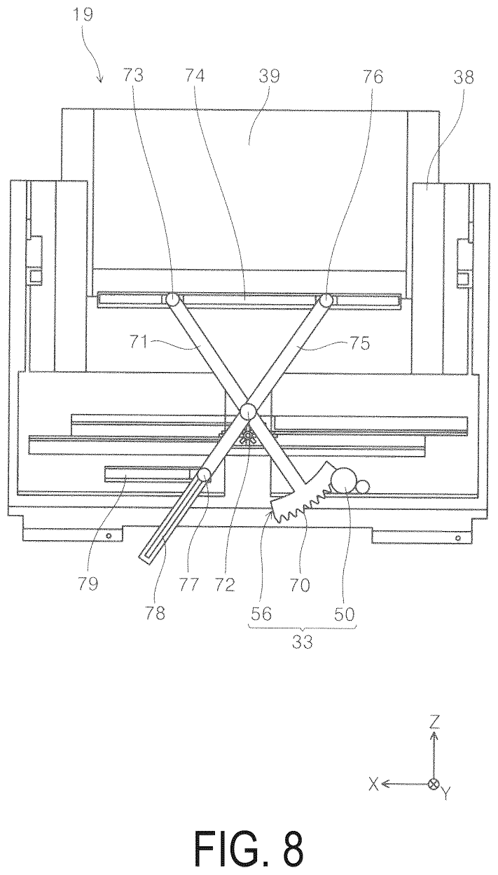

As illustrated in FIGS. 7 and 8, the placement part 19 includes the base tray 38, and the auxiliary tray 39 that can move in the extension and contraction direction relative to the base tray 38, as in Embodiment 1.

The extension and contraction change part 33 is different from that in Embodiment 1. That is, the extension and contraction change part 33 in Embodiment 2 includes a drive pinion 50, and a power transmission mechanism 56 that transmits rotational power of the drive pinion 50 to the auxiliary tray 39 to move the auxiliary tray 39.

The drive pinion 50 is driven by the drive source such as the motor (not illustrated). The drive pinion 50 is attached to a position on the −X side at a base end of the base tray 38. The control unit 22 controls the rotation of the drive pinion 50 based on the size information of the medium 2 to extend or contract the placement part 19 via the power transmission mechanism 56.

The power transmission mechanism 56 includes a first arm 71 and a second arm 75. The first arm 71 and the second arm 75 are rotatably attached to the shaft 72 along an X-Z plane in a state where the first arm 71 and the second arm 75 cross in an X-shaped form. The shaft 72 is fixed to an approximate center position of the base tray 38 in the X-axis direction. The first arm 71 includes a rack 70 at one end, and a projection 73 fixed to the other end. The second arm 75 has a projection 76 fixed to one end and a projection 77 at the other end. The projection 77 is attached to a long through-hole 78 provided in the second arm 75 to be movable in a longitudinal direction toward the shaft 72.

The auxiliary tray 39 has a long groove 74 in the X-axis direction at a base end. A groove 79 that is long in the X-axis direction is provided at a position on the +X side at the base end of the base tray 38. The groove 79 is shorter than the groove 74. The projection 73 and the projection 76 are slidably engaged with the groove 74. The projection 77 is slidably engaged with the groove 79. The rack 70 is engaged with the drive pinion 50 so that power can be transmitted.

It is obvious that the extension and contraction change part 33 of the present embodiment is not limited to a configuration using the drive pinion 50 and the power transmission mechanism 56. Further, the power transmission mechanism 56 is not limited to the above configuration, which is only an example.

### Step of Extending Placement Part

(1) In a state in FIG. 7, the control unit 22 receives size information of the medium 2. When the size information of the medium 2 indicates that the placement part 19 needs to be extended, the control unit 22 rotates the drive pinion 50 to pivot the first arm 71 via the rack 70. That is, the first arm 71 pivots with the shaft 72 as a fulcrum.

(2) Due to pivoting of the first arm 71, the projection 73 moves the groove 74 in the −X direction, and the auxiliary tray 39 is pushed and begins to be extended.

(3) At the same time, the projection 76 on the second arm 75 side begins to move in the +X direction. That is, the second arm 75 is pivoted. Accordingly, the auxiliary tray 39 begins to be extended while being pressed at two points by the projection 73 and the projection 76. The other projection 77 on the second arm 75 moves in a direction toward the shaft 72 inside the long through-hole 78 of the pivoted second arm 75 while moving in the −X direction in the groove 79.

(4) The control unit 22 stops the drive pinion 50 at a position where the auxiliary tray 39 has extended to a required length, resulting in a state in FIG. 8.

In the state in FIG. 8, the drive pinion 50 is rotated in a direction opposite to the above, so that the auxiliary tray 39 moves in the contraction direction and returns to the state in FIG. 7.

Further, in the present embodiment, the sensor 57 capable of acquiring information about the size of the medium 2 is provided. Here, an optical sensor is used as the sensor 57, but any sensor capable of acquiring the information about the size of the medium 2 may be used.

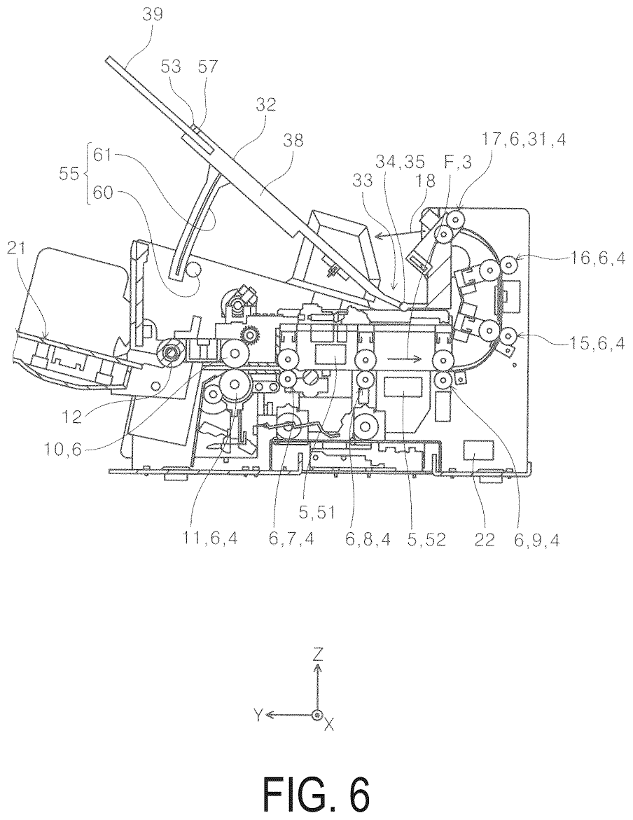

As illustrated in FIGS. 5 and 6, in the present embodiment, the sensor 57 is disposed at a downstream end 53 in the extension and contraction direction of the placement part 19. That is, the sensor 57 is attached to a downstream end 53 of the base tray 38. The control unit 22 is configured to extend or contract the placement part 19 based on information about the passage of the medium 2 acquired by the sensor 57.

Accordingly, when the sensor 57 detects the medium 2 in a state in FIG. 7, the auxiliary tray 39 is moved and the placement part 19 is extended, thereby curbing falling of the medium 2. A plurality of sensors 57 may be disposed in the direction along the placement surface 32. In this case, the plurality of sensors 57 are disposed in association with various sizes of the medium 2 to be discharged. Accordingly, it is possible to extend or contract the placement part 19 according to the size of the medium 2.

Further, as illustrated in FIGS. 5 and 6, in the present embodiment, the placement part 19 is configured to be pivotable in the vertical direction 36 with the base end 34 as the pivot fulcrum 35. Further, the placement angle change part 55 that changes a placement angle θ of the placement surface 32 relative to a horizontal plane 54 by pivoting the placement part 19 is included. The placement angle change part 55 includes a drive pinion 60 that is rotated by power transmitted from the drive source such as the motor (not illustrated), and a rack 61 that meshes with the drive pinion 60. In this configuration, the drive pinion 60 is rotated so that the placement part 19 pivots in the vertical direction 36 via the rack 61.

FIGS. 5 and 6 illustrate a state where the placement part 19 is pivoted upward from the state in FIG. 1. FIG. 5 illustrates a state where the placement part 19 has only been pivoted upward. FIG. 6 illustrates a state where the drive pinion 50 has been pivoted and the auxiliary tray 39 has been extended in the state in FIG. 5.

In the present embodiment, the drive pinion 50 can be rotated to move the auxiliary tray 39 at the position illustrated in FIG. 1 where the placement part 19 is not pivoted upward, and thus, it is obvious that the placement part 19 can be extended.

Further, the control unit 22 is configured to drive the placement angle change part 55 to change the placement angle θ based on the information about the discharged state of the medium 2 placed on the placement surface 32.

Here, “the information about the discharged state of the medium 2” means information about the alignment of a plurality of sheets of medium discharged to the placement part 19. In a specific example, this is information about the quality of the alignment of the medium 2 obtained by sensing with a sensor such as a camera (not illustrated), or information related to the alignment such as a size or type of the medium 2, a discharge speed from the discharge part 31, and an inclination angle of the placement surface 32 with respect to a horizontal plane. The latter information is input from an operation panel (not illustrated).

### Description of Effects of Embodiment 2

(1) In the present embodiment, the control unit 22 that controls the extension and contraction change part 33 is configured to extend or contract the placement part 19 based on the size information of the medium 2. Accordingly, the placement part 19 can be automatically extended or contracted by the control unit 22, making the device user-friendly.

(2) Further, in the present embodiment, the extension and contraction change part 33 includes the drive pinion 50, and the power transmission mechanism 56 that transmits the rotational power of the drive pinion 50 to the auxiliary tray 39 to move the auxiliary tray 39. The control unit 22 controls the rotation of the drive pinion 50 based on the size information of the medium to extend or contract the placement part 19. This makes it possible to automatically extend the placement part 19 with a simple structure in which the drive pinion 50 and the power transmission mechanism 56 are used.

(3) Further, in the present embodiment, the control unit 22 extends or contracts the placement part 19 based on the information about the size of the medium 2 acquired by the sensor 57. This makes it possible to automatically extend or contract the placement part 19 even when the user inputs the size information of the medium 2 from an operation panel or the like.

(4) Further, in the present embodiment, when the sensor 57 detects the medium 2 in the state of FIG. 5 where the placement part 19 is not extended, it is possible to determine that the medium 2 has a size requiring extension of the placement part 19. This makes it possible to appropriately extend or contract the placement part 19 according to the size of the medium 2. Further, it is possible to curb the medium 2 falling off the placement part 19.

For example, when the medium 2 discharged later comes into contact with the medium 2 first discharged from the discharge part 31 and placed on the placement part 19, the previously discharged medium 2 may be pushed, which may degrade the alignment. Further, when a discharge speed of the medium 2 discharged from the discharge part 31 is high, it is easy for the medium 2 to move more forward relative to the placement part 19, which degrades the alignment.

In the present embodiment, the control unit 22 drives the placement angle change part 55 to change the placement angle θ based on information about the discharged state of the medium 2 placed on the placement surface 32. This makes it possible to appropriately curb a forward movement of the medium 2 in the placement part 19 and improve the alignment.

### Other Embodiments

The medium discharge device 30 and the image reading device 1 according to the present disclosure are based on the configuration of the embodiment described above, but it is obvious that partial configurations may be changed or omitted without departing from the gist of the present disclosure.

The medium discharge device 30 can be mounted on a device other than the image reading device 1, and can also be mounted on and used in a recording device such as an inkjet printer, for example.

What is claimed is:

1. A medium discharge device comprising:
a discharge part configured to discharge a medium;
a placement part having a placement surface on which the medium discharged from the discharge part is placed and configured to extend or contract in a direction along the placement surface; and
an extension and contraction change part configured to extend or contract the placement part, wherein
the extension and contraction change part extends or contracts the placement part according to a size of the medium.

2. The medium discharge device according to claim 1, wherein
the placement part is pivotable in a vertical direction with a base end part as a pivot fulcrum, and
the extension and contraction change part extends the placement part in interlock with the pivoting of the placement part.

3. The medium discharge device according to claim 2, wherein
the extension and contraction change part extends the placement part in interlock with the placement part pivoting upward and then pivoting downward.

4. The medium discharge device according to claim 3, wherein
the placement part includes
a base tray,
an auxiliary tray configured to be movable in an extension and contraction direction relative to the base tray, and
an elastic member configured to apply an elastic force to the auxiliary tray in a contraction direction,
the extension and contraction change part includes an interlocking lever configured to interlock with the pivoting of the placement part, and
the interlocking lever moves the auxiliary tray in a direction in which the auxiliary tray extends against the elastic force in interlock with the pivoting of the placement part.

5. The medium discharge device according to claim 1, comprising:
a control unit configured to control the extension and contraction change part, wherein
the control unit extends or contracts the placement part based on size information about the medium.

6. The medium discharge device according to claim 5, wherein
the placement part includes
a base tray, and
an auxiliary tray configured to be movable in an extension and contraction direction relative to the base tray,
the extension and contraction change part includes
a drive pinion, and
a power transmission mechanism configured to transmit rotational power of the drive pinion to the auxiliary tray to move the auxiliary tray, and
the control unit controls the rotation of the drive pinion based on the size information about the medium to extend or contract the placement part.

7. The medium discharge device according to claim 5, comprising:
a sensor configured to acquire information about the size of the medium, wherein
the control unit extends and contracts the placement part based on the information acquired by the sensor.

8. The medium discharge device according to claim 7, wherein
the sensor is disposed at a downstream end in a direction in which the placement part extends and contracts.

9. The medium discharge device according to claim 5, wherein
the placement part is pivotable in a vertical direction with a base end as a pivot fulcrum,
the medium discharge device comprises a placement angle change part configured to change a placement angle of the placement surface relative to a horizontal plane by pivoting the placement part, and
the control unit drives the placement angle change part to change the placement angle, based on information about a discharged state of the medium placed on the placement surface.

10. An image reading device comprising:
the medium discharge device according to claim 1, and
a reading unit configured to read an image of the medium transported toward the medium discharge device.
